(19) United States
(12) Patent Application Publication
(10) Pub. No.: US 2024/0040942 A1
(43) Pub. Date: Feb. 8, 2024

(54) Multipurpose Gardening Tool

(71) Applicant: Barry Smith, New Carlisle, OH (US)

(72) Inventor: Barry Smith, New Carlisle, OH (US)

(21) Appl. No.: 18/296,414

(22) Filed: Apr. 6, 2023

Related U.S. Application Data
(60) Provisional application No. 63/394,658, filed on Aug. 3, 2022.

(51) Int. Cl. A01B 1/08

(52) U.S. Cl. CPC A01B 1/08

(57) ABSTRACT

The present invention relates to a multipurpose gardening tool for gardens, farms, landscapes and the like. The gardening tool features a handle, a curved neck and a metal blade. The neck and the handle can be integrally-attached or removably-attached as per the desire of a user. The neck includes a bend in a substantially C-shape, or arc shape that downwardly curves away from the handle. The metal blade is attached to the neck using a pair of metal pins or fasteners wherein the metal blade can be used for a variety of purposes like cultivating, seeding, planting, preparing seed beds, cultivating in between and around plants, digging up weeds and harvesting crops. The curved neck portion enables a user to remove weeds without inadvertently destroying the surrounding plants.

### CROSS-REFERENCE TO RELATED APPLICATION

The present application claims priority to, and the benefit of, U.S. Provisional Application No. 63/394,658, which was filed on Aug. 3, 2022 and is incorporated herein by reference in its entirety.

### FIELD OF THE INVENTION

The present invention relates generally to the field of gardening tools. More specifically, the present invention relates to a multipurpose garden hoe designed for a variety of purposes in a garden or a farm. The hoe features an elongated handle, a curved neck and a metal blade. The neck curves downwardly away from the handle and includes the metal blade attached thereto. The shape of the neck is such that the metal blade is positioned linearly with the handle. The metal blade is flat and can have a beveled edge. Further, the hoe is lightweight and can be easily navigated around plants without destroying roots or surrounding plants. Accordingly, the present disclosure makes specific reference thereto. Nonetheless, it is to be appreciated that aspects of the present invention are also equally applicable to other like applications, devices and methods of manufacture.

### BACKGROUND

By way of background, manual gardening tools are abundantly used by people in both personal and professional gardening. A hoe is a garden hand tool used to cultivate the soil and remove weeds and the common garden hoe is still one of the most widely used manual gardening devices. Garden hoes generally chop weeds and soil, cultivate the surface of the soil, and cut weed roots below the surface. As weeds can quickly get out of control in a garden and may become uncontrollable, individuals generally have a hard time eliminating the weeds with existing garden hoes. Standard hoes prohibit an individual to cultivate at a fast rate, do not allow for optimal control and can also result in inadvertent plants and roots being destroyed.

A straight handle extending to the blade in a conventional hoe decreases range of cultivating on the soil by an individual. In some cases, the uniform trenches may not be formed with conventional hoes. Further, large blades are required in conventional hoes that necessitate more power from the user to operate the hoe. A user may have to bend over and the hoe can be obstructed by the weeds during use. Further, conventional hoes can include a working end that is obstructed from a view of the user.

Therefore, there exists a long felt need in the art for an improved garden hoe that includes a lightweight body that makes it easy for users to navigate around plants. There is also a long felt need in the art for a garden hoe that does not destroy roots or surrounding plants. Additionally, there is a long felt need in the art for a garden hoe that cultivates the soil and eliminates the weeds easily. Moreover, there is a long felt need in the art for a garden hoe that enables for optimal control and forms uniform trenches. Further, there is a long felt need in the art for a multipurpose garden hoe device that can easily navigate through plants and is not obstructed in use or view. Finally, there is a long felt need in the art for an improved garden hoe that can be used for cultivating, seeding, planting, preparing seed beds, cultivating in between and around plants, digging up weeds and harvesting crops.

The subject matter disclosed and claimed herein, in one embodiment thereof, comprises a garden hoe tool. The gardening tool features an elongated handle (i.e. wooden handle) that includes a length from about 30 inches to about 54 inches. The elongated handle includes an ergonomic grip at one end and a curved metal neck connected to, and extending from, another opposing end. The curved metal neck includes a length from about 6 inches to about 18 inches. A flat metal blade is removably-connected to the curved metal neck wherein the flat metal blade can be connected to the curved metal neck using mechanical fasteners. The metal blade can be used for cultivating with, and in, the soil.

In this manner, the novel garden hoe of the present invention accomplishes all of the forgoing objectives, and provides a relatively effective, lightweight and convenient tool to eliminate weeds while protecting the surrounding plants and roots. The tool can be used in a variety of ways in a garden or on the farm such as cultivating, seeding, planting, preparing seed beds, cultivating in between and around plants, digging up weeds and harvesting crops.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a multi-functional gardening tool. The gardening tool is designed to be employed for cultivating, seeding, planting, preparing seed beds, cultivating in between and around plants, digging up weeds and harvesting crops. The gardening tool further comprising an elongated handle having a length from about 30 inches to about 54 inches, the elongated handle having a first end and a second end, the first end having an ergonomic grip, a radiused and curved metal neck connected to and extending from the second end of the elongated handle, the curved metal neck having a length from about 8 inches to about 18 inches, and a flat metal blade removably-connected to the curved metal neck wherein the flat metal blade can be connected to the curved metal neck using mechanical fasteners and can be used for working with, and in, the soil. The curved metal neck curves downwardly away from the second end for a first portion of a curved metal neck length and then curves inwards for a second portion of the curved metal neck length so that a plane of the metal blade is positioned generally in a transverse or orthogonal position with respect to the handle and the metal blade is configured generally in linear orientation.

In yet another embodiment, the curved metal neck is one or more of substantially C—shape, substantially scoop shape, or substantially arc-shape.

In yet another embodiment, the curved metal neck is formed from a single metal piece.

In yet another embodiment, the curved metal neck includes a hollow end for receiving the second end of the elongated handle.

In yet another embodiment of the present invention, a garden hoe device is disclosed. The garden hoe device includes an elongated handle having a gripping end and a terminal end, the terminal end having a curved metal neck mounted thereto using mechanical fasteners, the curved metal neck having a slotted end, the slotted end having a metal blade attached thereto wherein the metal blade can include a beveled edge. The curved metal neck enables easy navigation and easy viewing around plants without destroying roots and surrounding plants.

In yet another embodiment of the present invention, the terminal end of the handle includes holes for receiving selectively-removable mechanical fasteners and the gripping end includes an ergonomic grip.

In yet another embodiment of the present invention, a method of using a multifunctional garden hoe for removing weeds without inadvertently destroying roots or surrounding plants is disclosed. The method includes the step of initially providing a gardening tool comprising a handle (i.e. wooden handle), an attached curved metal neck length, and a metal blade terminal or working end. The method also includes the step of securing the curved neck length proximal end to one end of the wooden handle using a first set of mechanical fasteners and securing the metal blade to the curved length distal end using a second set of mechanical fasteners. The method further includes inserting the trailing edge of the metal blade into soil or roots of the weeds, cutting the weed using the metal blade, and then removing the trailing edge of the metal blade from the soil.

In yet another embodiment of the present invention, the curved length or C-shaped metal neck having a length from about 8 inches to about 18 inches.

In yet another embodiment of the present invention, the flat base is non-slipping and includes a beveled edge.

In yet another embodiment, the flat base includes a plurality of slots for creating troughs.

The advantage of the garden hoe of the present invention is that it enables users to employ the device for cultivating, seeding, planting, preparing seed beds, cultivating in between and around plants, digging up weeds, and harvesting crops. The device is lightweight and protects the roots or surrounding plants from being inadvertently destroyed while effectively removing weeds. The device comes in a variety of sizes, colors, and designs to be used in a variety of ways in a garden or farm. The tool is compact and sound in design, as well as being efficient and versatile in use.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a garden hoe tool of the present invention in accordance with the disclosed architecture;

FIG. 2 illustrates a perspective view of a user using the gardening tool of FIG. 1 for removing a weed in accordance with the disclosed architecture;

FIG. 3 illustrates a perspective view of one potential embodiment of the gardening tool of the present invention used with the soil in accordance with the disclosed architecture; and

FIG. 4 illustrates a partial perspective view of another potential embodiment of the garden hoe of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for an improved garden hoe that includes a lightweight body that makes it easy for users to navigate around plants. There is also a long felt need in the art for a garden hoe that does not destroy roots or surrounding plants. Additionally, there is a long felt need in the art for a garden hoe that cultivates the soil and eliminates the weeds easily. Moreover, there is a long felt need in the art for a garden hoe that enables for optimal control and forms uniform trenches. Further, there is a long felt need in the art for a multipurpose garden hoe device that can easily navigate through plants and is not obstructed in use or view. Finally, there is a long felt need in the art for an improved garden hoe that can be used for cultivating, seeding, planting, preparing seed beds, cultivating in between and around plants, digging up weeds and harvesting crops.

The present invention, in one exemplary embodiment, is a novel garden hoe device. The garden hoe device features an elongated handle having a gripping end and a terminal end, wherein the terminal end comprises a curved metal neck mounted thereto using mechanical fasteners. The curved metal neck includes a slotted end, wherein the slotted end includes a metal blade attached thereto. Further, the metal blade includes a beveled or knife edge (i.e. leading edge). The curved metal neck enables easy navigation around plants without inadvertently destroying desirable roots of surrounding plants.

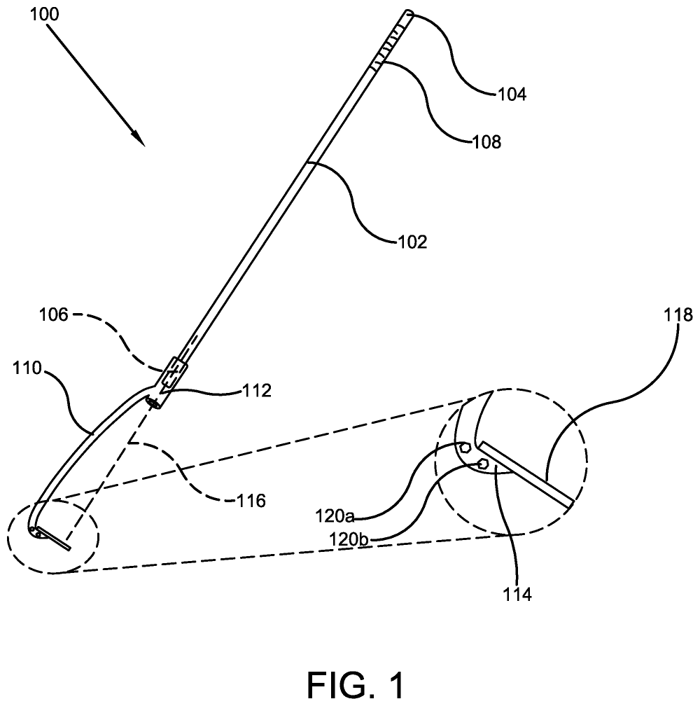

Referring initially to the drawings, FIG. 1 illustrates a perspective view of one potential embodiment of a garden hoe tool 100 of the present invention in accordance with the disclosed architecture. The garden hoe tool 100 in the present embodiment is designed as a lightweight tool for a variety of purposes in a garden, landscaping bed or a farm. The tool 100 is easy to navigate around desirable plants without destroying roots and plants. More specifically, the tool 100 includes an elongated and tubular handle 102 that is configured to be held by a user during use of the tool 100. The elongated handle 102 includes a first or gripping end 104 and a second or terminating (i.e. mounting) end 106. The gripping end 104 includes an ergonomic grip 108 that can be used for comfortable gripping of the handle 102. The handle 102 can include a length generally from about 30 inches to about 54 inches from the first gripping end 104 to the second mounting end 106. The variations in the length allow an individual to increase range of use of the tool 100 without bending or sitting. In the present invention, the handle 102 is preferably formed of wood. However, other materials such as plastics, metals, fiberglass, composites, etc., can also be used.

A curved or arc-shaped metal mounting length 110 also referred to as curved metal neck is integrally or removably-attached to the second or distal end 106 of the handle 102. The curved metal neck 110 includes a linear hollow portion 112 that receives the second end 106 of the handle 102 for securing the neck 110 and the handle 102 using mechanical fasteners such as rivets or screws. Alternatively, the fasteners may not be required and the hollow portion 112 and the second end 106 can be permanently-attached to each other through a means such as welding. The curved length 110 curves downwardly away from the hollow portion 112 and the second end 106, and thus provides more clearance to navigate around plants in comparison to conventional garden hoes. At the end of the curved length 110, the curved length 110 bends inwards so that the other end 114 of the curved length 110 can be positioned linearly with the longitudinal axis 116 of the handle 102. In one potential embodiment, the curved portion 110 can include a length generally from about 8 inches to about 18 inches.

A generally flat or linear metal blade 118 is attached to the end 114 of the curved length 110 such that the metal blade 118 extends in a direction generally transverse or orthogonal to the handle 102. This enables a user to use the tool 100 in a similar manner to a conventional garden hoe. The metal blade 118 can be attached to the end 114 using screws or metal pins 120a, 120b. The blade 118, in one potential embodiment, comprises a generally rectangular shape having a first or front cutting edge and a second or rear cutting edge in order to break through the soil working surface and allowing soil to be pulled or pushed. The blade 118 is also used for cutting through weeds efficiently while the curved neck 110 enables users to navigate the blade 118 easily around plants. In addition, the blade 118 is preferably made of a metal, so that the blade 118 is rigid and able to withstand rugged use.

It should be noted that the substantially transverse orientation of the blade 118 relative to the handle 102 enables a user to easily cultivate the soil and remove weeds. The metal blade 118 can comprise any geometric shape and can have mounting slots through the surface of the blade 118. The blade 118 can include a width or height generally from about ½ inch to about 2 inches; and can include a length generally from about 2 inches to about 6 inches.

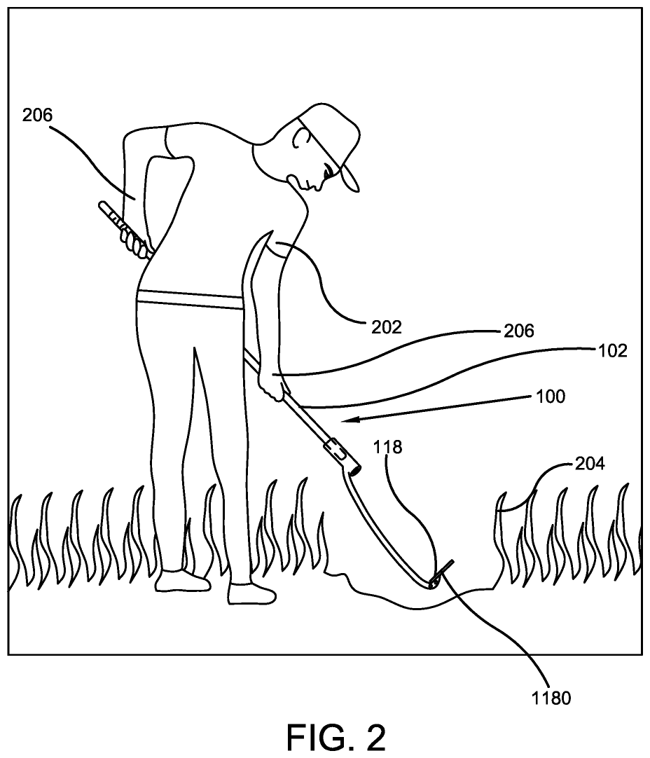

FIG. 2 illustrates a perspective view of a user using the gardening tool 100 of FIG. 1 for removing a weed in accordance with the disclosed architecture. A user 202 cultivating in a garden, landscaping bed or farm can use the tool 100 for a variety of purposes such as cultivating, seeding, planting, preparing seed beds, cultivating in between and around plants, digging up weeds and harvesting crops. In the present embodiment, the tool 100 is used by the user 202 for removing a weed 204. As shown, the handle 102 is held by both hands 206 and the trailing edge 1180 of the metal blade 118 is placed at the weed 204. The sharp trailing edge 1180 of the blade 118 cuts the weed 204 even when a small push is applied by the user 202. The hoe 100 can be used to remove weeds 204 from narrow rows such as flowers and vegetable seedlings as the curved neck 110 is not obstructed by the surrounding plants. Due to the long handle 102, the user 202 does not have to sit or kneel for removing the weeds 204.

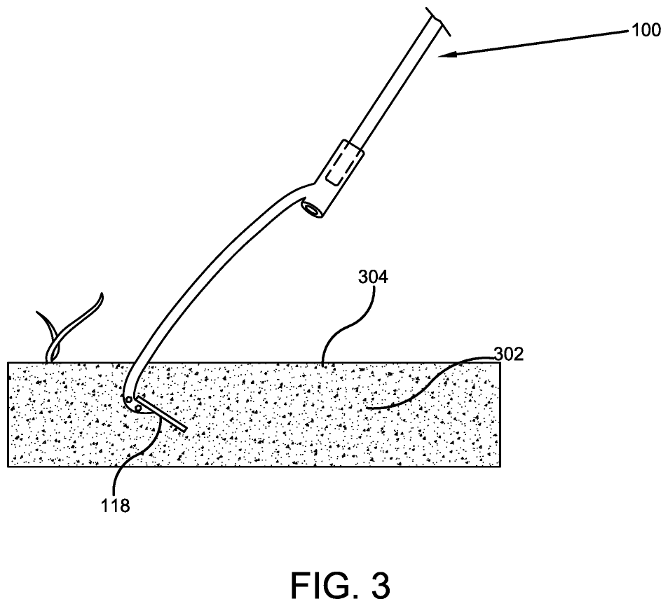

FIG. 3 illustrates a perspective view of the gardening tool 100 of the present invention used with the soil in accordance with the disclosed architecture. The gardening tool 100 can be deployed for soil 302 cultivation, weeding, and/or planting seeds. The tool 100 can also be used for effective aeration of soil 302. As shown, the metal blade 118 is inserted to a desired depth underneath the top surface 304 of the soil 302. The blade 118 can be positioned at an angle or generally level with the ground as per the desire of a user. The blade 118 can be moved back and forth for cultivating and breaking up the soil 302. The predetermined length and width of the blade 118 can be at least partially controlled by the choice of length for the handle 102 and the objective of using the tool 100.

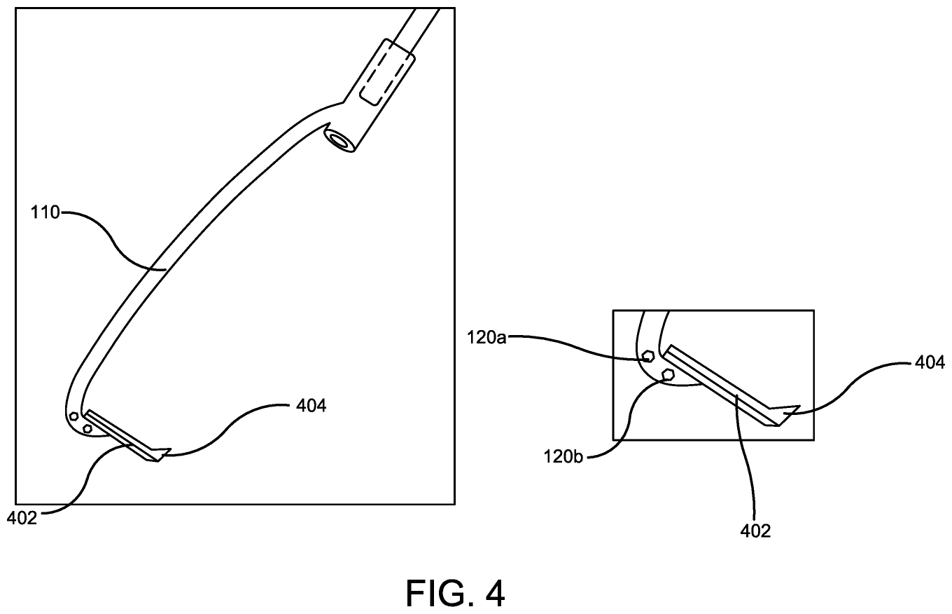

FIG. 4 illustrates a partial perspective view of another embodiment of the garden hoe of the present invention in accordance with the disclosed architecture. In one potential embodiment, the tool 400 includes a metal blade 402 connected to the curved neck 110 using the metal pins or fasteners 120a, 120b. The blade 402 is replaceable. The blade 402 can include an angled outer edge 404. The angled outer edge 404 can be configured to provide ground penetration, soil separation and raking functions. The angled outer edge 404 is also useful for scraping and cutting weeds and grasses.

The weed removal tool 100 of the present invention is an ideal weed-cutting gardening tool that includes sharp cutting edges on the metal blade. The purpose of this structure is to facilitate the easy cutting and removal of unwanted plants such as weeds. The curved neck enables a user to reach hard-to-reach areas such as in narrow seedling lanes of vegetables. Regardless of blade type, the overall shape of the neck is substantially C-shaped, arc shaped, or a generally curved shaped. The elongated handle, along with the curved neck portion, provides even more flexibility in use of the tool while cutting weeds. The tool 100 of the present invention has the advantages that its structural design is compact, includes simple manufacturing, and is convenient to use.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “weed removal tool”, “multifunctional garden hoe”, “garden hoe”, “garden hoe tool”, “tool”, and “device”, are interchangeable and refer to the garden hoe tool 100, 400 of the present invention.

Notwithstanding the forgoing, the garden hoe tool 100, 400 of the present invention can be of any suitable size and configuration as is known in the art without affecting the overall concept of the invention, provided that it accomplishes the above-stated objectives. One of ordinary skill in the art will appreciate that the size, configuration and material of the garden hoe tool 100, 400 as shown in the FIGS. are for illustrative purposes only, and that many other sizes and shapes of the garden hoe tool 100, 400 are well within the scope of the present disclosure. Although the dimensions of the garden hoe tool 100, 400 are important design parameters for user convenience, the garden hoe tool 100, 400 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cultivating and weeding garden tool comprising:
an elongated handle configured to be held by a user during use;
wherein said elongated handle includes a first gripping end and a second mounting end;
wherein said first gripping end includes an ergonomic grip;
wherein said elongated handle includes a length generally from about 30 inches to about 54 inches;
a curved metal neck portion including a receiving end mounted to said second mounting end of said elongated handle;
wherein said curved metal neck portion includes a length generally from about 8 inches to about 18 inches;
a generally linear metal blade connected to a terminal end of said curved metal neck portion; and
further wherein said generally linear metal blade includes a width generally from about ½ inch to about 2 inches.

2. The cultivating and weeding garden tool of claim 1, wherein said elongated handle includes a material selected from a group consisting of a wood, a plastic, a metal and a fiberglass.

3. The cultivating and weeding garden tool of claim 1, wherein said generally linear metal blade includes a length from about 2 inches to about 6 inches.

4. The cultivating and weeding garden tool of claim 3, wherein said generally linear metal blade extends in a direction generally orthogonal to a longitudinal axis of said elongated handle.

5. The cultivating and weeding garden tool of claim 4, wherein said curved metal neck portion includes a first portion extending away from said longitudinal axis of said elongated handle and a second portion extending toward said longitudinal axis of said elongated handle.

6. The cultivating and weeding garden tool of claim 5, wherein said generally linear metal blade includes an angled outer edge.

7. The cultivating and weeding garden tool of claim 4, wherein said generally linear metal blade is rectangular in shape.

8. The cultivating and weeding garden tool of claim 7, wherein said generally linear metal blade includes a sharpened trailing edge for cutting a weed.

9. The cultivating and weeding garden tool of claim 8, wherein said generally linear metal blade is replaceable.

10. A cultivating and weeding garden tool comprising:
an elongated handle configured to be held by a user during use;
wherein said elongated handle includes a first gripping end and a second mounting end;
wherein said first gripping end includes an ergonomic grip;
wherein said elongated handle includes a length generally from about 30 inches to about 54 inches;
a curved metal neck portion including a receiving end mounted to said second mounting end of said handle;
wherein said curved metal neck portion includes a length generally from about 8 inches to about 18 inches;
a generally linear metal blade connected to a terminal end of said curved metal neck portion;
wherein said generally linear metal blade is rectangular in shape; and
further wherein said generally linear metal blade includes an angled outer edge.

11. The cultivating and weeding garden tool of claim 10, wherein said elongated handle includes a material selected from a group consisting of a wood, a plastic, a metal and a fiberglass.

12. The cultivating and weeding garden tool of claim 11, wherein said generally linear metal blade includes a length from about 2 inches to about 6 inches.

13. The cultivating and weeding garden tool of claim 12, wherein said generally linear metal blade extends in a direction generally orthogonal to a longitudinal axis of said elongated handle.

14. The cultivating and weeding garden tool of claim 13, wherein said curved metal neck portion includes a first portion extending away from said longitudinal axis of said elongated handle and a second portion extending toward said longitudinal axis of said elongated handle.

15. The cultivating and weeding garden tool of claim 14, wherein said generally linear metal blade includes a width generally from about ½ inch to about 2 inches.

16. The cultivating and weeding garden tool of claim 15, wherein said generally linear metal blade includes a sharpened trailing edge for cutting a weed.

17. The cultivating and weeding garden tool of claim 16, wherein said generally linear metal blade is replaceable.

18. A cultivating and weeding garden tool comprising:
an elongated handle configured to be held by a user during use;
wherein said elongated handle includes a first gripping end and a second mounting end;
wherein said elongated handle includes a length generally from about 30 inches to about 54 inches;
a curved metal neck portion including a receiving end mounted to said second mounting end of said elongated handle;
a generally linear metal blade connected to a terminal end of said curved metal neck portion;
wherein said generally linear metal blade is rectangular in shape;
wherein said generally linear metal blade extends in a direction generally orthogonal to a longitudinal axis of said elongated handle; and
further wherein said curved metal neck portion includes a first portion extending away from said longitudinal axis of said elongated handle and a second portion extending toward said longitudinal axis of said elongated handle.

19. The cultivating and weeding garden tool of claim 18, wherein said generally linear metal blade includes a length from about 2 inches to about 6 inches and an angled outer edge.

20. The cultivating and weeding garden tool of claim 19, wherein said curved metal neck portion includes a length generally from about 8 inches to about 18 inches.
